(19) United States
(12) Patent Application Publication
(10) Pub. No.: US 2014/0127411 A1
(43) Pub. Date: May 8, 2014

(54) FABRICATION METHOD FOR METAL-SUPPORTED NANO-GRAPHITE

(71) Applicant: IHI Corporation, Koto-Ku (JP)

(72) Inventors: Akihiko YOSHIMURA, Tokyo (JP); Takahiro MATSUO, Tokyo (JP); Masaru TACHIBANA, Kanagawa (JP); Seog Chul SHIN, Kanagawa (JP)

(73) Assignee: IHI Corporation, Koto-ku (JP)

(21) Appl. No.: 14/148,921

(22) Filed: Jan. 7, 2014

Related U.S. Application Data
(63) Continuation of application No. PCT/JP2012/069441, filed on Jul. 31, 2012.

(30) Foreign Application Priority Data
Aug. 9, 2011 (JP) 2011-173995

(51) Int. Cl. C01B 31/02

(52) U.S. Cl. CPC C01B 31/0293
USPC 427/343

(57) ABSTRACT

To fabricate a metal-supported nano-graphite with easy processing. The invention includes the steps of: using carbon nanowalls formed on a substrate to produce carbon nanowall pieces which are each composed of one or plural nano-graphite domains smaller than the carbon nanowalls; mixing metal to be supported with a liquid in which the produced carbon nanowall pieces are dispersed; and injecting a reducing agent into the liquid containing the carbon nanowall pieces and metal to cause the metal to be supported on the carbon nanowall pieces.

### CROSS REFERENCE TO THE RELATED APPLICATIONS

This application is a continuation application of international application No. PCT/JP2012/69441, filed on Jul. 31, 2012, which claims priority to Japanese Patent Application No. 2011-173995. filed on Aug. 9, 2011, each of which is hereby incorporated by reference in their entity.

### FIELD OF INVENTION

The present invention relates to a method of fabricating a metal-supported nano-graphite.

### RELATED ART

Carbon nanowalls (CNWs) are a kind of two-dimensional carbon material having such a shape that curved sheets stand on a substrate. The carbon nanowalls are composed of crystallites with good crystallinity (see Non-patent Literature 1, for example).

Carbon nanowalls are being expected to be applied as metal supports in the light of the large specific surface area thereof coming from the structure thereof. Studies are being made on electrodes of fuel cells to which metal-supported carbon materials are applied, and carbon nanowalls are also being studied to be used in fuel cell electrodes. To be specific, carbon nanowalls can be used in fuel cell electrodes by being configured to support platinum.

The methods conventionally used in order to evenly disperse platinum supported on the carbon material generally includes: dispersing a carbon material and a precursor to platinum in an aqueous solution and using reduction to cause platinum to be supported on the carbon material. On the other hand, the carbon nanowalls are formed on a substrate with a high aspect ratio at which the height is greater than the width. Accordingly, there is a difficulty in evenly disperse the supported platinum up to the bottom near the substrate.

Accordingly, for example, a method is examined which performs a contact treatment of a platinum compound dissolved in supercritical CO₂ with carbon nanowalls and heats the same to 300 to 800° C. to precipitate platinum on the surfaces of the carbon nanowalls (see Patent Literature 1, for example).

### CITATION LIST

### Patent Literature

Patent Literature 1: Japanese Patent Laid-open Publication No. 2006-273613

### Non-Patent Literature

Non-patent Literature 1: K. Kobayashi & six others, “Nano-graphite domains in carbon nanowalls,” J. Appl. Phys, 2007, 101, 094306-1, 3

### SUMMARY OF INVENTION

### Problems to be Solved by Invention

However, the technique described in Patent Literature 1 requires a device for handling the supercritical fluid, and the system thereof is complicated. It is therefore difficult to implement the technique easily.

In the light of the aforementioned problem. an object of the present invention is to provide a method of fabricating a metal-supported nano-graphite that can be implemented with easy processing.

### Means for Solving Problem

To achieve the aforementioned object, an invention of claim 1 is a method of fabricating a metal-supported nano-graphite which includes the steps of: using carbon nanowalls formed on a substrate to produce carbon nanowall pieces that are each composed of one or a plurality of nano-graphite domains smaller than the carbon nanowalls; mixing metal to be supported with a liquid, wherein the produced carbon nanowall pieces are dispersed; and injecting a reducing agent into the liquid containing the carbon nanowall pieces and metal to cause the metal to be supported on the carbon nanowall pieces.

In an invention of claim 2, the step of producing the carbon nanowalls includes the steps of: scraping the carbon nanowalls from the substrate; and pulverizing the scraped carbon nanowalls.

In an invention of claim 3, platinum is mixed in the step of mixing the metal.

### EFFECT OF INVENTION

According to the present invention, it is possible to fabricate a metal-supported nano-graphite with easy processing.

### BRIEF DESCRIPTION OF DRAWINGS

FIGS. 1A and 1B are schematic views for explaining structures of carbon nanowalls and nano-graphite domains.

FIGS. 2A to 2C are schematic views explaining production of nano-graphite.

FIG. 3 is an example of the SEM image of carbon nanowall pieces.

FIGS. 4A and 4B show another example of the SEM image of the carbon nanowall pieces.

FIGS. 5A and 5B are examples of the Raman scattering spectrum of carbon nanowall pieces.

FIGS. 6A and 6B are examples of the cyclic voltammogram of carbon nanowalls and carbon nanowall pieces.

### MODES FOR CARRYING OUT INVENTION

A method of fabricating a metal-supported nano-graphite according to an embodiment of the present invention includes: a step of using carbon nanowalls formed on a substrate to produce carbon nanowall pieces which are each composed of one or plural nano-graphite domains smaller than carbon nanowalls (step 1); a step of mixing metal to be supported with a liquid in which the produced carbon nanowall pieces are dispersed (step 2); and a step of injecting a reducing agent to the liquid containing the carbon nanowall pieces and metal to cause the metal to be supported on the carbon nanowall pieces (step 3).

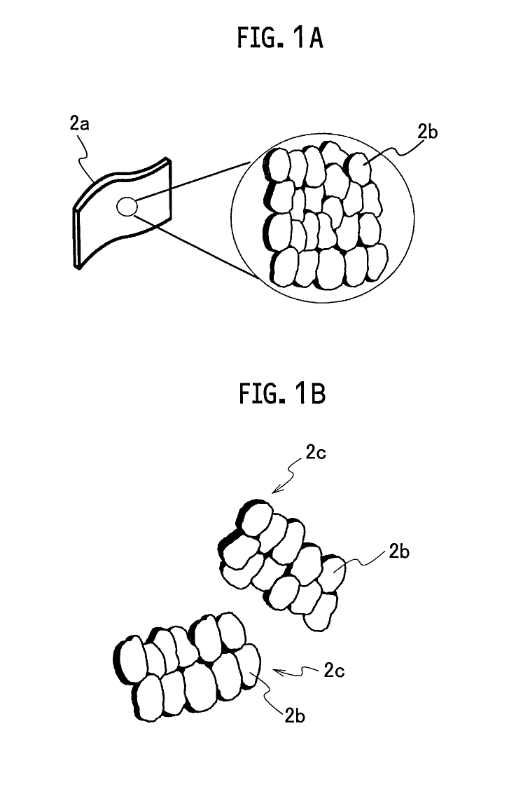

Each carbon nanowall 2a is composed of plural nano-graphite domains 2b as illustrated in FIG. 1A. When the carbon nanowalls 2a are pulverized, the carbon nanowalls 2a break down into plural carbon nanowall pieces 2c as illustrated in FIG. 1B. Each carbon nanowall piece 2c is also composed of plural nano-graphite domains 2b. If the carbon nanowall pieces 2c are further pulverized, single nano-graphite domains 2b can be obtained. In other words, the substances that have a graphite structure and are smaller than the carbon nanowalls 2a include the single nano-graphite domains 2b and the carbon nanowall pieces 2c composed of plural nano-graphite domains 2b.

### (Step 1)

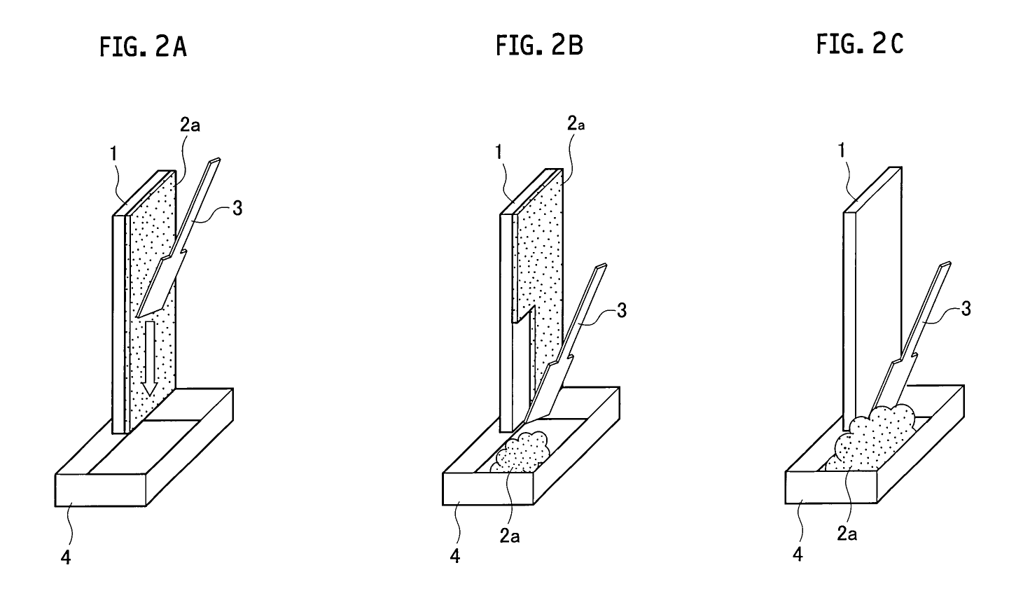

First, using FIGS. 2A to 2C, a description is given of an example of a process of producing nano-graphite intended to support metal from the carbon nanowalls 2a (step 1). The carbon nanowalls 2a can be produced on a substrate such as a silicon (Si) substrate 1 by a process such as plasma CVD. On the silicon substrate 1, the plural carbon nanowalls 2a are densely provided.

First, the plural carbon nanowalls 2a formed on the silicon substrate 1 as illustrated in FIG. 2A are scraped off with a scraper 3 as illustrated in FIG. 2B. The carbon nanowalls 2a scraped from the silicon substrate 1 are collected into a non-charged case 4 as illustrated in FIGS. 2B and 2C.

When all the carbon nanowalls 2a on the silicon substrate 1 are scraped and collected to the non-charged case 4 as illustrated in FIG. 2C, the collected carbon nanowalls 2a are compressed and pulverized with a pulverizer (not shown) to produce carbon nanowall pieces each composed of one or plural nano-graphite domains. The nano-graphite domains are substances constituting the carbon nanowalls 2a. The nano-graphite domains have a graphite structure similarly to the carbon nanowalls 2a but are smaller than the carbon nanowalls 2a.

The method of producing the carbon nanowall pieces is not limited to the aforementioned method that separately performs scraping from the silicon substrate 1 and pulverization and may be a method that scrapes the carbon nanowalls 2a from the silicon substrate 1 and simultaneously pulverizes the same.

### (Step 2)

Next, a description is given of an example of a process of mixing metal to be supported with the liquid containing the carbon nanowall pieces dispersed (step 2). First, the nano-graphite obtained by the process of Step 1 is dispersed into a liquid such as distilled water. Subsequently, metal such as a platinum precursor is then mixed with the liquid containing the carbon nanowall pieces dispersed.

Herein, the liquid used for mixing the carbon nanowall pieces and metal can be, in addition to the aforementioned distilled water, pure water with impurities removed, such as ion exchange water. The metal to be mixed with the distilled water can be chloroplatinic acid hexahydrate, which is a platinum precursor, for example. Moreover, the metal to be mixed with the distilled water can be selected according to the intended purpose of the carbon nanowall pieces and may be a metal such as nickel.

### (Step 3)

Next, a description is given of a process of causing metal to be supported on the carbon nanowall pieces. Herein, a reducing agent is injected into the liquid containing the carbon nanowall pieces and metal so that platinum is supported on the carbon nanowall pieces. The reducing agent can be formaldehyde. for example.

As described above, the method of fabricating a metal-supported nano-graphite according to the embodiment can be easily implemented by mixing in a liquid, metal and carbon nanowall pieces which are composed of one or plural nano-graphite domains produced from carbon nanowalls and by using reduction.

In the case of using a metal-supported carbon material in an electrode, for example, the carbon material is applied to metallic foil, carbon paper, or the like to be used as the electrode. Accordingly, even in the case of using carbon nanowalls, the carbon nanowalls provided on a substrate cannot be used as an electrode without being processed. Accordingly, by producing carbon nanowall pieces and then causing metal to be supported on the produced carbon nanowall pieces like the fabrication method according to the embodiment, a metal-supported carbon material having the same effect can be finally obtained with easy processing.

In addition to facilitation of the fabrication process, using carbon nanowall pieces instead of carbon nanowalls can increase the amount of supported platinum compared to the case of using carbon nanowalls and can increase the total surface area of the supported platinum. Accordingly. the performance of the carbon material as the electrode material can be improved, for example.

### Examples

Next, a description is given of examples in which carbon nanowall pieces are obtained using carbon nanowalls produced on a silicon substrate of 10×10 cm². Herein, in the described examples, about 100 mg of carbon nanowalls were obtained by repeating the production under the following conditions three times: the substrate temperature is 500° C.; the discharge current, 70 A; the gas flow rates of Ar, H₂, and CH₄, 80 sccm, 10 sccm, and 10 sccm; the reaction pressure, 3.0×10⁻³ Torr; and the reaction time, 360 min.

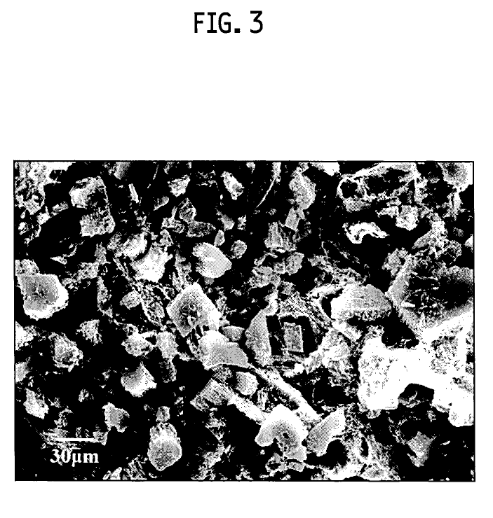

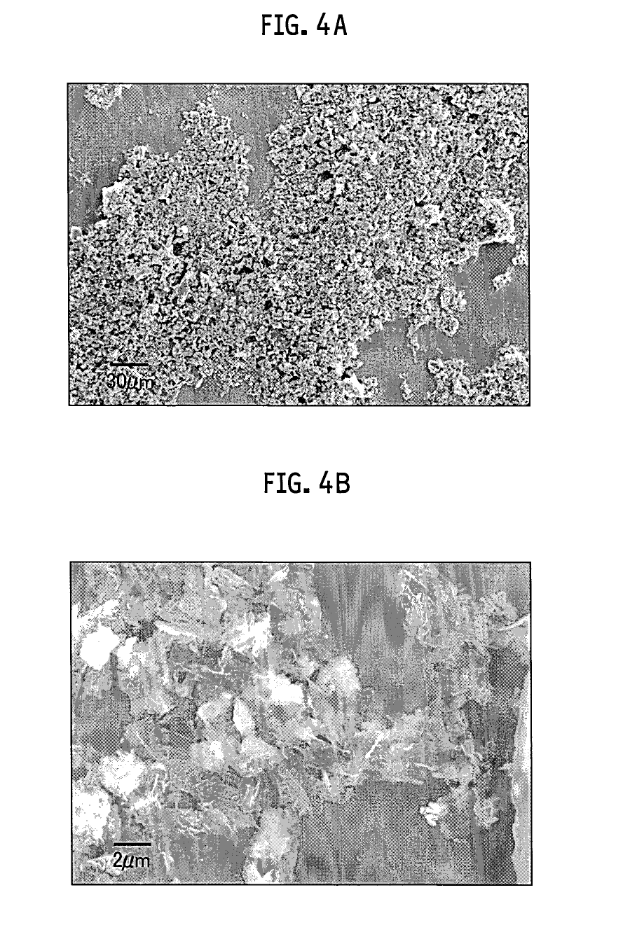

FIGS. 3, 4A, and 4B are examples of the SEM image of carbon nanowall pieces obtained by scraping the obtained 100 mg of carbon nanowalls from a silicon substrate by the method described above using FIGS. 2A to 2C and pulverizing the same by hand. To be specific, FIG. 3 is an SEM image of carbon wall pieces obtained by pulverizing the carbon nanowalls by hand with an agate mortar and a meddler for five minutes. FIGS. 4A and 4B are SEM images of carbon wall pieces obtained by pulverizing the carbon nanowalls in a similar manner by hand for 20 minutes. FIGS. 4A and 4B are images of the same carbon nanowall pieces but are shown at different magnifications.

Comparison of the images of FIGS. 3, 4A, and 4B reveals that the longer the pulverization time, the finer the carbon nanowall pieces. The average size of carbon nanowalls was 18 μm×1.5 μm×several nm before pulverization. The average size of carbon nanowall pieces of FIGS. 4A and 4B was 5 μm×1.5 μm×several nm. Herein, the size of nano-graphite domains is less than the size of the obtained carbon nanowall pieces, and each carbon nanowall piece is composed of nano-graphite domains.

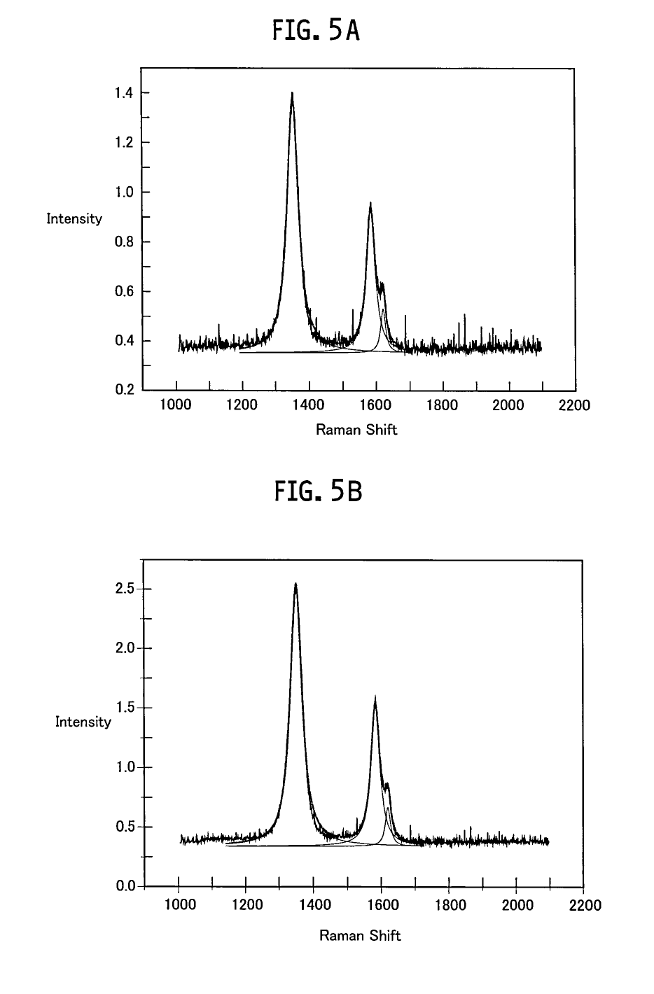

FIGS. 5A and 5B respectively show the Raman scattering spectrum (FIG. 5A) of carbon nanowalls on the silicon substrate and the Raman scattering spectrum of the carbon nanowall pieces obtained by pulverization (FIG. 5B). In FIGS. 5A and 5B, the vertical axis represents the Raman scattering intensity, and horizontal axis represents the Raman shift.

The crystallinity of carbon materials can be evaluated by using the intensity ratio I_{D}/I_{G} of the D-band to G-band, which is obtained by using two peaks including: the D-band (around 1350 cm⁻¹) and G-band (around 1580 cm⁻¹) appearing in the Raman scattering spectrum, and the half-value width W_{G} of the G-band. In this case, the lower the crystallinity, the higher the value of I_{D}/I_{G}, and the larger the value of W_{G}.

In the Raman scattering spectrum of the carbon nanowalls on the silicon substrate, which is shown in FIG. 5A, D/G is about 1.7, and W_{G} is about 32. The Raman scattering spectrum shown in FIG. 5B is the Raman scattering spectrum of the carbon nanowall pieces obtained by pulverizing carbon nanowalls for 20 minutes, in which I_{D}/I_{G} is about 1.4 and W_{G} is about 32.

In the Raman scattering spectra shown in FIGS. 5A and 5B. I_{D}/I_{G} and W_{G} do not greatly change between before pulverization (carbon nanowalls) and after pulverization (carbon nanowall pieces). This reveals that the crystal structure of carbon nanowalls is not broken even in the carbon nanowall pieces obtained by pulverization.

The spectrum illustrated in FIG. 5A is an average spectrum of three types of samples obtained by the production repeated three times. The spectrum illustrated in FIG. 5B is the spectrum for the carbon nanowall pieces obtained by mixing and pulverizing the three types of samples.

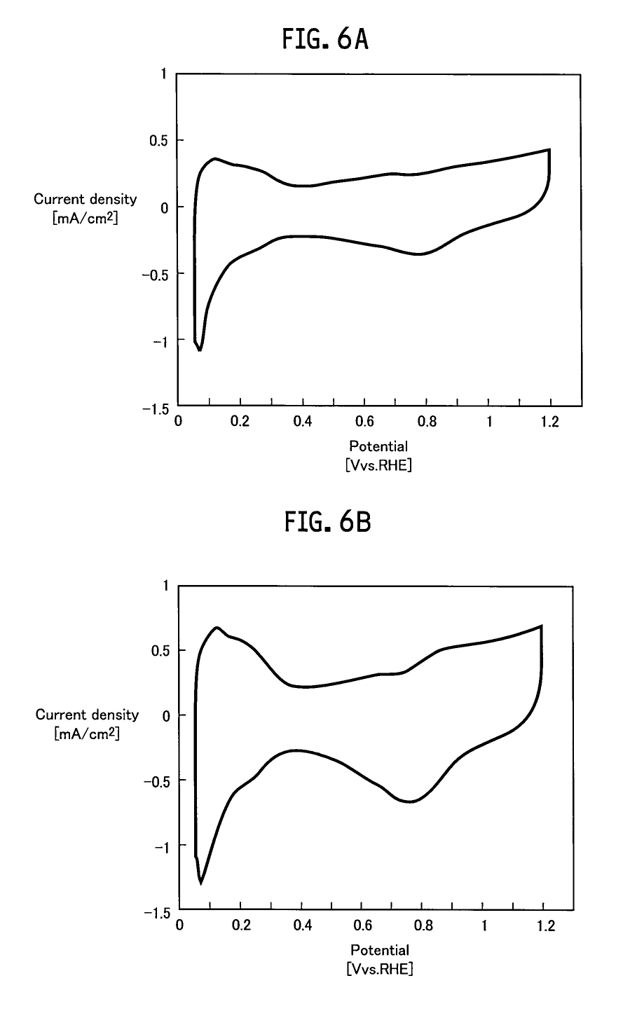

Next, FIGS. 6A and 6B respectively show a cyclic voltammogram in the case where platinum is supported by carbon nanowalls (FIG. 6A) and a cyclic voltammogram in the case where platinum is supported by carbon nanowall pieces (FIG. 6B). The cyclic voltammograms are to evaluate electrode materials using current density and potential.

The electrochemical active surface areas (ECSA) obtained from the cyclic voltammogram representing the properties of the carbon nanowalls scraped from a substrate illustrated in FIG. 6A is 26.7 (m²/g·Pt). The ECSA obtained from the cyclic voltammogram representing the properties of the carbon nanowall pieces obtained by pulverizing carbon nanowalls for 20 minutes, which is illustrated in FIG. 6B, is 53.5 (m²/g·Pt).

This reveals that the surface area of the supported platinum is larger in the case where platinum is supported by carbon nanowall pieces than that in the case where platinum is supported by carbon nanowalls. Accordingly, in the case of using carbon materials for electrodes, it is revealed that the electrodes obtained by using the platinum-supported carbon nanowall pieces have higher performances than electrodes obtained by using platinum-supported carbon nanowalls.

Hereinabove, the present invention is described in detail using the embodiment but is not limited to the embodiment described in the specification. The scope of the present invention is determined by description of claims and equivalents thereof.

### EXPLANATION OF REFERENTIAL NUMERALS

1 SILICON SUBSTRATE

2a CARBON NANOWALL

2b NANO-GRAPHITE DOMAINS

2c CARBON NANOWALL PIECES

3 SCRAPER

4 NON-CHARGED CASE

What is claimed is:

1. A method of fabricating a metal-supported nano-graphite. comprising the steps of:
using carbon nanowalls formed on a substrate to produce carbon nanowall pieces that are each composed of one or a plurality of nano-graphite domains smaller than the carbon nanowalls;
mixing metal to be supported with a liquid, wherein the produced carbon nanowall pieces are dispersed; and
injecting a reducing agent into the liquid containing the carbon nanowall pieces and metal to cause the metal to be supported on the carbon nanowall pieces.

2. The method of fabricating a metal-supported nano-graphite according to claim 1, wherein
the step of producing the carbon nanowalls includes the steps of:
scraping the carbon nanowalls from the substrate; and
pulverizing the scraped carbon nanowalls.

3. The method of fabricating a metal-supported nano-graphite according to claim 1, wherein in the step of mixing the metal, platinum is mixed.
